(19) United States
(12) Patent Application Publication
(10) Pub. No.: US 2006/0083878 A1
(43) Pub. Date: Apr. 20, 2006

(54) Fire-resistant plastic tanks and containers

(76) Inventor: Bernard D. Bauman, Katy, TX (US)

Correspondence Address: Sanford J. Piltch, Esq., Suite 201, 1132 Hamilton Street, Allentown, PA, 18101-1024, US

(21) Appl. No.: 10/969,583

(22) Filed: Oct. 20, 2004

(51) Int. Cl. B32B 27/08

(52) U.S. Cl. 428/35.7

(57) ABSTRACT

A molded plastic container having one or more of its surfaces modified by contacting those surfaces with a reactive gas atmosphere containing fluorine, chlorine, oxygen, ozone, sulfur trioxide, peroxide, oxidative acids, or mixtures thereof to increase the surface energy of those one or more surfaces to at least 40 dynes/cm to enhance the adhesion of coatings to those surfaces, a fire-resistant intumescent or ceramic microsphere coating adhered to said modified surfaces to improve the longevity and integrity of the container when exposed to the heat of a fire, and optionally, a barrier coating adhered under said modified surfaces to reduce permeation of oxygen, carbon dioxide, and organic fluids through the container walls; and a method for producing such a molded plastic container comprising modifying at least one surface of the container with a halogenated gas atmosphere to increase the surface energy of that surface, optionally coating said modified surface with a permeation barrier layer, and subsequently coating said modified surface with an intumescent or ceramic microsphere fire protective material.

### BACKGROUND OF THE INVENTION

The present invention relates generally to the manufacture of plastic articles, pipes, and containers that have superior resistance to melting and burning when exposed to fire. More particularly, the present invention relates to a method of preparing the surface of the plastic articles to enable them to be coated with and to adhere well to an intumescent coating.

Polyethylene and other types of plastics have found increasing use as replacements for metal and glass in the packaging and containment of flammable liquid products. Examples of such products include pesticides and automotive products that contain hydrocarbons such as benzene, toluene, hexane, and other volatile, flammable liquids; and gasoline. Compared with conventional metal containers, plastic is lighter in weight, corrosion resistant, potentially less expensive, more easily formable into complex shapes, and has greater impact and puncture resistance. Compared with glass containers, plastic is much more resistant to breakage and is lighter in weight, potentially less expensive, and more easily formable into complex shapes. Shortcomings in the organic barrier properties of polyethylene and polypropylene, which did present major limitations to the use of those materials for containing various organic liquids, including gasoline, gasohol, benzene, toluene, hexane, etc., have been largely overcome with a variety of organic barrier technologies. Examples of these technologies include coextrusion of multilayer containers, sulfonation, fluorination, barrier coatings, and incorporation of barrier additives.

However, one deficiency in the use of plastic containers and tanks for containing flammable liquids remains: their susceptibility to melting and burning when exposed to fire, which leads to failure of containment, and in addition, fuel to the fire. This susceptibility presents serious safety hazards with regard to the storage of flammable liquids in plastic containers.

Fire Resistance

There are two problems associated with the fire resistance of plastic containers: melting of the plastic and burning of the plastic. Either one of these problems leads to failure of the container. One approach for solving the problem of plastic containers melting when exposed to fire is to crosslink the plastic after the container has been molded. Crosslinking causes chemical bonds to be formed between polymer chains, which results in formation of a three-dimensional chain network. A crosslinked polymer will not melt. However, excessive heating eventually results in decomposition and burning, and container failure. Crosslinking is not widely used because it has significant costs, it slows production rates, and it prevents the material as scrap, or at end-of-life from being recycled.

To reduce the combustibility of plastic, there are a number of additives that can be used. The main effect of these additives is to reduce the chances of a fire starting by providing increased resistance to ignition. When ignition does occur, flame retardants act to delay the spread of flame, providing extra time in the early stages when the fire can be extinguished or an escape can be made. Some examples of these “flame retardants” include ammonium phosphate, antimony trioxide, Tris (2-chloro-1-methylethyl) phosphate (TCPP), Tris (2-chloroethyl) phosphate (TCEP), tetrabromobispenol A (TBBPA), hexabromocyclododecane (HBCD), Penta- and Octabromodiphenyl ether (Penta- and OctaBDE), short chain chlorinated paraffins (SCCP), and many others. However, flame retardants have little value in benefiting plastic containers holding flammable liquids when exposed to fire because the plastic will still melt and cause failure of the container.

Another approach for improving the fire-resistance of materials is through the use of intumescents. Intumescents are materials that undergo a thermal degradation upon exposure to elevated temperatures, which produces a thermally stable, foamed, multi-cellular residue called “intumescent char”. When an intumescent-containing material is exposed to fire, it can form an insulating char layer that inhibits heat-damage, melting, thermal decomposition, and burning. The intumescent approach has been used for about 50 years in coatings to protect metal and wood structures. Intumescent chemicals can be incorporated in a variety of coatings systems, including epoxy, urea formaldehyde, polyurethane, latex, water-borne, and solvent-borne. However, intumescent coatings cannot be used on articles molded in polyethylene, polypropylene, and many other polymeric and plastic materials because of inadequate adhesion between the coating and the article surface.

Another approach to improving fire-resistance of plastics, which involves use of intumescents, is to compound intumescent chemicals into the plastic prior to molding into the finished item. However, this approach has experienced limited success and it is totally inapplicable to polyolefins and other thermoplastics that are used to make plastic containers. This approach cannot be used for thermoplastics because of two technical reasons. The thermoplastics are not char forming and, when exposed to fire, they decompose quantitatively to form gaseous monomers, which then burn. Also, attempts to combine the high loading levels of intumescent chemicals required to make this work pose great challenges in making homogeneous mixes and such loading levels greatly diminish physical properties such as strength and toughness.

Another approach to improving the fire-resistance of materials is through the use of ceramic insulative coatings. These coatings contain large amounts of ceramic (or glass) hollow spheres, with the microspheres being white in color. When incorporated into a coating, the ceramic microspheres significantly increase the capacity of the coating to reflect infrared radiation so that far less heat is absorbed into the coating and the coating (and underlying substrate) can withstand higher temperatures and/or longer periods of time before beginning to break down. The microspheres also greatly increase the thermal insulation properties of the coating. In addition, ceramic microspheres will not burn when exposed to fire. All of these properties, taken together, result in greatly reduced heat transfer to substrates when ceramic microspheres are used in a coating, regardless of whether the heat source is fire or sunlight.

Intumescent Coatings

Intumescent flame-retardant coatings have the characteristic that they decompose and foam when exposed to elevated temperatures of a fire, forming an insulating and non-combustible char layer that prevents, or at least hinders, the passage of heat to the underlying substrate material. As an intumescent coating swells, it provides an insulating barrier between the fire and the coated substrate. This insulating barrier is necessary to ensure the structural performance of the substrate during a fully developed fire, by preventing or slowing the softening and melting of the plastic article.

For an intumescent coating to provide this insulating barrier to the plastic substrate, both the coating expansion under heat and the retention of the char layer must be considered. Intumescent coatings typically expand approximately 15 to 30 or more times in volume when exposed to fire. In addition, most intumescent coatings generate a char or ash-like layer during the expansion process. As the fire exposure continues, the ash coating erodes, exposing the remaining intumescent coating. This expansion process may repeat itself several times during fire exposure, depending on the coating thickness. The maintenance of the insulating or char layer during the expansion and erosion process is highly dependent on the shape of the underlying substrate. While the char may adhere well to a flat surface, the same material may not, by itself, adhere adequately to protect a corner or other rounded or arcuate shape. Therefore, some intumescent coatings require the addition of a reinforcing mesh when applied on specific structural shapes in order to retain their insulating or char layer when exposed to the elevated temperatures of a fire.

Importance of Adhesion

The application of intumescent or fire resistive ceramic-filled coatings to polyethylene or polyolefin substrates has heretofore been impractical where the coating is subjected to severe and prolonged environmental and physical conditions, primarily because of the difficulty of achieving good adhesion of the coatings to the polymer substrate. Merely getting s fire-resistive coating to “hang” onto a substrate is not sufficient. Excellent adhesion is required in order for the coating to last years of service prior to a fire, and the coating must adhere strongly enough that it does not blow off during the stress of a fire.

Various attempts have been made in addressing the problem of applying fire protective coatings to plastic containers. For example, U.S. Pat. No. 6,737,131 [Garcia] discloses a multi-layered blow molded fluid tank wherein the outer blow molded layer comprises polyolefin and a non-halogen char forming additive to prevent flammability. U.S. Pat. No. 5,723,515 [Gottfried] discloses a composition for an intumescent fire-retardant coating that is durable and suitable for a wide variety of substrate materials, but does not address the issue of adherence of the intumescent coating to a plastic or thermoplastic substrate. U.S. Patent Application Publication 2003/0008090 A1 [Rhode, et al.] discloses a hollow plastic article with one or more layers, of which at least one layer comprises flame retardants, and discusses the possible presence of barrier layers to ensure bonding between the base layer and the layer comprising the flame retardant. However, there is no surface preparation to create such a bond-enhancing barrier layer suggested or disclosed.

A white paper entitled “Transfer Technology—Fire Resistant Fiberglass Pipe” issued by the Fiberglass Tank and Pipe Institute discusses coating fiberglass reinforced thermosetting plastic (FRP) with an intumescent coating to gain longevity in a fire situation. It is unclear from this paper whether such an application has ever been put into practice. Additionally, the proposed application relates only to thermosetting plastics and there is no indication that surface modification was performed prior to the application of the intumescent coating onto the outer surface of the pipe.

While there is a substantial body of prior patents, as discussed above, concerning surface modification of plastics, particularly polyolefins, to enable adhesion of coatings, the present invention is the first to describe the combination of surface modification of a plastic article followed by binding a flame retardant coating to the underlying article.

Therefore, it is an object of the present invention to provide a plastic article, such as a fluid container or tank, with an outer surface treated to greatly enhance the ability of an intumescent or fire-resistive coating to adhere thereto. It is an additional object of the present invention to provide a fire-resistive coated plastic container that can withstand exposure to flame temperatures without failing to contain its contents. It is a further object of the present invention to provide a plastic container with both a barrier coating and a fire-resistive coating, so that such a container can have reduced permeation of gases or liquids contained therein, retain its impact resistance, and have the ability to withstand fire conditions without structural degradation.

It is another object of the present invention to provide a method for treating the surface of a plastic polyethylene or other polyolefin material to increase the surface energy sufficiently to enhance surface adherence of barrier and intumescent coatings. It is yet another object of the present invention to provide a method for manufacturing a plastic tank having superior permeation barrier properties and fire-resistive properties.

Other objects will appear hereinafter.

### SUMMARY OF THE INVENTION

The present invention encompasses molded polymer forms coated with a fire resistive or intumescent coating and methods for producing such intumescent or fire resistive coated polymer forms. More particularly, the present invention may be a molded polyethylene or polyolefin container having its surface modified by exposure to a halogenated gas (or some other appropriate surface modification process) to increase surface energy to improve adherence of a fire protective coating. Additionally, the container of the present invention may include a barrier layer coating to reduce the permeability of the container to oxygen, carbon dioxide, and organic liquids and gases, the adherence of the barrier coating to the polymer container also being enhanced by the halogen gas (or other) surface modification.

Containers of the present invention, and containers made using the methods of the present invention, are ideal for the storage of flammable liquids such as fuels. Polymer containers are widely used as fuel tanks in automotive and other applications. The present invention further improves such containers by providing protection of the tank and tank contents in the event of exposure to an external fire, as may occur in a traffic accident. The intumescent coating substantially reduces the risk of the tank overheating during exposure to a fire so that such a coated tank will be dramatically less likely to fail than an uncoated tank; the risk of an explosion or worsened fire is greatly reduced with an intumescent-coated tank. Testing data of fuel tanks intumescently coated by the method of the present invention proves the efficacy of such intumescent coatings in protecting the integrity of such polymer tanks.

Most importantly, the surface modification of the polymer tank prior to the application of either (or both) the intumescent coating or the fire resistive coating, as is done in the present invention, significantly enhances adhesion of the coating to the modified surfaces of the polymer container. As a result, the coating will be in place to perform its function despite prolonged periods of use and exposure to environmental and physical conditions that could cause a less well-adhered coating to become detached from the container surface. Without the surface modification of the present invention, fire-resistive or intumescent coatings applied to polymer surfaces will likely not give adequate adhesion to ensure that they remain affixed to the polymer container until they may be needed.

### BRIEF DESCRIPTION OF THE DRAWINGS

For the purpose of illustrating the invention, there is shown in the drawings forms which are presently preferred; it being understood, however, that the invention is not limited to the precise arrangements and instrumentalities shown.

FIG. 1 is a graphical representation of the heat rise in an uncoated fluid container, when exposed to fire in the U.S. Coast Guard Fire Test.

FIG. 2 is a graphical representation of the heat rise in a fluid container having an intumescent coating, when exposed to fire in the U.S. Coast Guard Fire Test.

### DETAILED DESCRIPTION OF THE PREFERRED EMBODIMENT

The following detailed description is of the best presently contemplated mode of carrying out the invention. The description is not intended in a limiting sense, and is made solely for the purpose of illustrating the general principles of the invention. The various features and advantages of the present invention may be more readily understood with reference to the following detailed description taken in conjunction with the accompanying drawings.

The present invention combines the steps of surface modification of a plastic container to increase coating adhesion and application of a fire-resistive coating to the exterior surface of the container. It is the combination of surface preparation with the addition of a flame retardant intumescent coating that creates improved fire protection of plastic containers when compared with any methods of the prior art. The present invention relates both to the method of surface modification of plastic containers and the subsequent coating of those containers with fire-resistive or intumescent coatings, as well as to the method of surface modification of the plastic resin prior to molding the container shape and the subsequent coating of those later-molded containers with fire-resistive or intumescent coatings.

A plastic tank or container is first formed; made wholly or in part from polyethylene and other polyolefins. A surface modification step follows to provide excellent adhesion properties to the outer surface of the container. Alternatively, the surface modification step is performed first to enhance the adhesion properties of the plastic material, followed by the molding of the modified plastic into a container. As an option, a barrier coating may then be applied and cured to provide good permeation barrier properties for oxygen, carbon dioxide, and/or organic material, to retain the important property of high impact resistance, and to provide a surface to which an additional layer, such as an intumescent coating, will strongly adhere. A fire protective coating is subsequently applied. Optionally, a protective topcoat may be applied over the intumescent coating to provide additional resistance to abrasion and damage due to harsh environmental or operating conditions.

Surface Modification

For enhanced adhesion of both optional barrier coatings and intumescent coatings, the surface of molded plastic items may be modified by a variety of methods. Such surface modification can occur either before or after molding the plastic into the final container shape. Regardless the method, in order to achieve adequate adhesion to polyethylene and other polyolefin containers and tanks, the chemical structure of the surface must be modified in a way that creates oxygen-containing functional groups, such as hydroxyl (I), carboxyl (II), hydroperoxy (III), and/or sulfonic acid groups (IV). 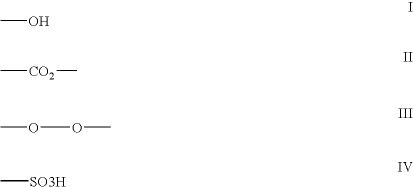
Furthermore, to facilitate excellent coating adhesion, there must be sufficient concentration of these oxygen-containing functional groups on the modified surface such that the surface energy is increased to at least 40 dynes/cm.

Methods of surface modification include exposure to a reactive gas atmosphere, exposure to oxidative acids or liquids, plasma treatment, corona treatment, flame treatment, and exposure to ultraviolet light or other radiation energy sources. Reactive gas atmospheres may include components such as fluorine (F₂), chlorine (Cl₂), oxygen (O₂), ozone (O₃), and sulfur trioxide (SO₃). The preferred approach is to expose the plastic container to a reactive gas atmosphere with a gas mixture comprising fluorine or sulfur trioxide or both. An overview of the method is as follows.

The container is placed into a chamber, to which is added the reactive atmosphere. The preferred reactive atmosphere gas comprises, by volume, approximately 0.1% to approximately 20% F₂ and approximately 0.5% to approximately 30% O₂. The atmosphere is applied at temperatures ranging from ambient to approximately 120° F. After sufficient exposure time, which may range from approximately 5 seconds to approximately 4 hours, the reactive atmosphere and its subsequent byproducts are removed and the plastic item is taken out of the chamber.

There is a plurality of possible methods for admitting the reactive gas atmosphere into the chamber. A partial vacuum may be drawn on the chamber, after which the reactive gas is flowed into the chamber. The reactive gas may be either a premixed blend of gases, or may be only the most reactive component that blends with the gas already in the chamber to create the desired gas composition. Following adequate exposure time, the reactive gases in the chamber may be removed by repeating the steps of pulling a vacuum (or reducing the gas pressure) within the chamber followed by adding air or other inert gas or fluid. Alternatively, the reactive gas may be removed by purging with a constant flow of air or other inert gas into the chamber through one orifice while simultaneously removing a constant flow of the chamber's contents through a second orifice.

Another approach for introducing a reactive gas into the chamber is a flow-through method. After the plastic container is placed into the chamber, a pre-blended mixture of reactive gases is continuously flowed into the chamber through an orifice. The chamber is held at a constant low pressure by permitting the gas contents of the chamber to simultaneously flow out of the chamber through a second orifice. After adequate exposure time, the inlet gas is changed from the reactive gas to air, or another inert gas or fluid, in order to sweep the reactive gas out of the chamber. In all processes utilizing reactive gas treatment, it is desirable to pass the gas atmosphere through a scrubber prior to discharge into the atmosphere in order to remove any toxic and reactive species.

An example of reactive gas surface treatment of a plastic tank is as follows. A fuel tank molded in polyethylene and with dimensions approximately 15 inches by 7 inches by 12 inches is placed in a reactive chamber measuring 24 inches by 35 inches by 30 inches. The chamber is sealed and a vacuum pump reduces the pressure within the chamber from 760 mm Hg (atmospheric pressure) to 745 mm Hg. From a cylinder of 100% gaseous fluorine attached to the chamber, fluorine gas is added until the pressure within the chamber is again 760 mm Hg. The atmosphere is left in contact with the plastic container for 10 minutes. Then, a vacuum is pulled on the chamber until the pressure is reduced to 5 mm Hg. Air is admitted into the chamber to achieve a pressure of 760 mm Hg again. The cycle of vacuum and addition is repeated twice more, to adequately dilute any remaining fluorine gas, and then the chamber is opened. The surface modified plastic tank may be removed and is now ready to be coated.

Oxidative liquids or acids that can be used to surface modify plastic containers include sulfuric acid, fuming nitric acid, hydrogen peroxide, chromic acid, and potassium permanganate. Surface modification can be performed with these liquids by either dipping a container into the liquids or by spray or brush coating the liquids onto the surface. Liquid contact is maintained on the surface for sufficient time to achieve the required surface functionalization, after which time the container surface is usually rinsed with water and dried prior to coating.

Plasma treatment may be accomplished by placing the container into a chamber and exposing it to a plasma. Plasmas are generated when electrical energy is applied to a gas, usually at low pressure, resulting in the formation of high-energy, very reactive species that react with the polymer surfaces. Corona treatment may be accomplished by causing an electrostatic discharge to occur at the plastic surface that is to be modified. Generally, corona treatment is performed at ambient pressures.

Flame treatment is achieved by exposing the plastic surface to the flame of a burner fueled by a gaseous fuel such as methane, natural gas, acetylene, or hydrogen, such that the surface is chemically oxidized but the container material is not melted. Plastic container surfaces may also be modified by exposure to other sources of high-energy radiation, including X-ray and ultraviolet light.

Intumescent Coating

The method of the present invention is capable of manufacturing fire-protected products from a broad range of plastics and other synthetic polymeric materials, including polyethylene, polypropylene, nylon, polyester, polyurethane, epoxy, PVC, acetal, and styrene. A critical requirement for an intumescent coating in this application is that it must begin to decompose and intumesce at a temperature lower than the melting point of the underlying plastic substrate. There are many intumescent fire-resistive coatings commercially available with this characteristic, including some that are water-based, epoxy-based, polyurethane-based, urea formaldehyde-based resins. Some examples of commercially available fire retardant intumescent coating are: FX-100® by Flame Seal Products, Inc. of Houston, Tex.; CKC-F-268 by Hy-Tech Thermal Solutions, Inc. of Melbourne, Fla.; Pycotex by Interex International, Ltd. of Lancashire, United Kingdom; Firesteel by Firetherm Intumescent and Insulation Supplies, Ltd. of Kent, United Kingdom; Firetex by Altex Coatings, Ltd. of Bay of Plenty, New Zealand; A/D Firefilm® by AD Fire Protection Systems, Ltd. of Ontario, Canada; Taikalitt by Nippon Paint Company of Osaka, Japan; and Safecoat Products by Eagle Specialized Coatings and Protected Environments, a division of DW Pearce Enterprises, Ltd. of British Columbia, Canada, among others. While some may perform better than others in particular situations, all are amenable to use with the present inventive application.

Ceramic Microsphere Coating

The method of the present invention is also capable of manufacturing fire-protected products from a range of ceramic insulative coating materials. These coatings contain large amounts of ceramic (or glass) hollow microspheres, with the microspheres being white in color. When incorporated into an epoxy (or similar polymer) resin binder to form a coating, the ceramic microspheres significantly increase the capability of the coating to reflect infrared radiation so that far less heat is absorbed into the coating and the coating can withstand higher temperatures before beginning to break down, or intumesce. The microspheres also greatly increase the thermal insulation properties of the coating. In addition, the ceramic microspheres will not burn when exposed to fire. All of these properties, taken together, result in a greatly reduced heat transfer to substrates when ceramic microspheres are used in a coating, regardless of whether the heat source is fire or sunlight.

Incorporation of ceramic microspheres will result in the inhibition of heat transfer into and through the coating and lengthen the time from initial exposure of a formed plastic vessel or container to a fire environment and the combustion of the container and its contents. One example of a commercially available ceramic insulation coating product is the Supertherm product line manufactured by Eagle Specialized Coatings and Protected Environments, a division of DW Pearce Enterprises, Ltd. of British Columbia, Canada. Other coatings can be made fire-resistive through the incorporation of ceramic microspheres, such as Hy-Tech Insulating Additive sold by Hy Tech Corporation, Melbourne, Fla.

Intumescent or fire-resistive coatings may be applied by any of the processes that are known to the coatings industry. These include spray coating, dipping, applying with a brush or roller, powder coating, and vapor deposition to a thickness in the range of between 10 and 20 mils. To help control the directional growth and stability of the developing char layer when exposed to flame temperatures, the intumescent or fire resistive coating may optionally contain a mesh or fibrous additive.

Many specific products may be surface treated and subsequently coated with intumescent or fire resistive coatings as described herein, including all types of plastic fuel tanks for automobiles, marine vessels, off-road vehicles, construction equipment, and farm equipment. Additionally, plastic vessels used to contain flammable, combustible, highly volatile, or dangerous chemicals may be surface treated and coated with intumescent material, including shipping drums, storage drums, supersacks, and large storage vessels. Further, plastic hoses, pipes, and conduits use to transport liquids or gases may be surface treated and coated with intumescent material, including those used in refueling stations, rapid implementation fuel transport systems (RIFTS), fire-fighting water and chemical distribution systems, and chemical and oil process industries.

Fire-Resistive Testing of Coated Tanks

Six fuel tanks were evaluated in a marine fire resistance test performed by IMANNA Laboratory, Inc., in Rockledge, Fla. These tests were done in accordance with the United States Coast Guard (USCG) and the American Boat and Yacht Council (ABYC) requirements. Four of these tanks were molded in polyethylene and surface modified, but not coated with an intumescent coating. The remaining two tanks were molded in polyethylene, surface modified, and coated with an intumescent coating. Each fuel tank was subjected to an open flame fire test using a NMMA/USCG typical installation fire test fixture. The fire tests were conducted per USCG Fuel System Standard Test Procedure (June 1980), specifically following Lab Exam 9 of that test procedure. The temperature of the fuel inside the tank and the temperature outside the tank were recorded for each test.

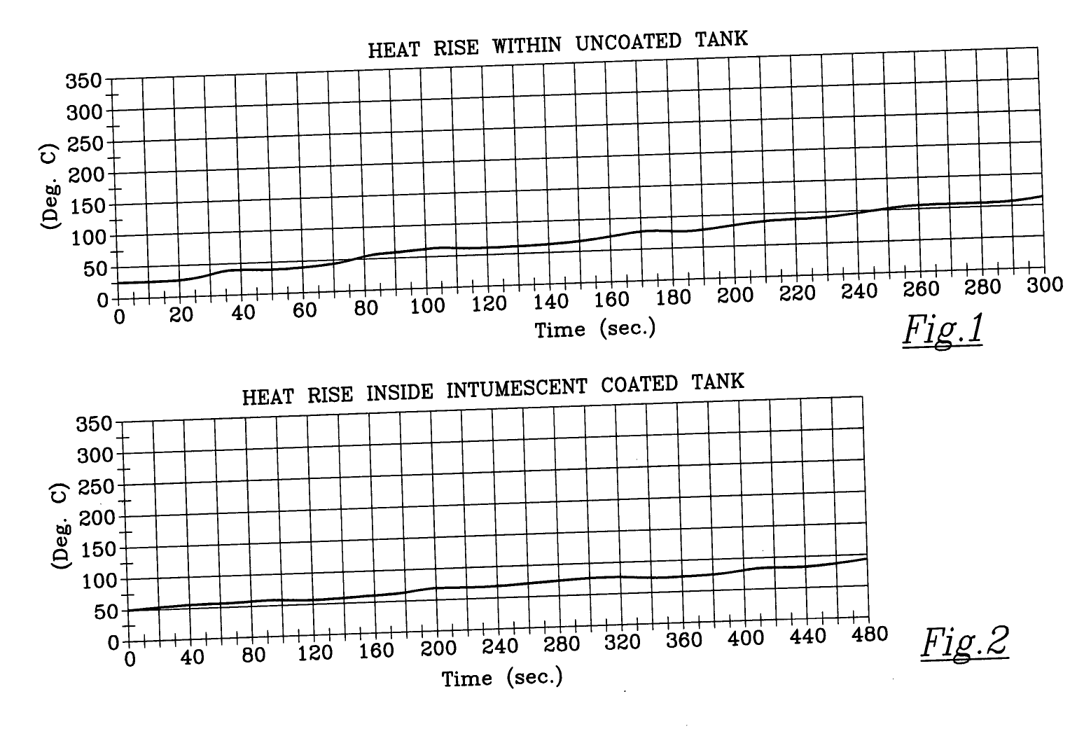

Temperature data from a representative test of container 3B is shown in FIG. 1. Container 3B was an uncoated tank having a thermocouple sensor inside the tank and another on the outer surface of the tank. The data shows that the temperature of the fluid (gasoline) in the tank increased from 25° C. to 100° C. in about 250 seconds. This corresponds to a heat transfer rate that yields 0.30° C. temperature rise/second, a significant increase in the internal temperature of the fluid in the container. In contrast, the fluid within container B-3B, an intumescent coated tank, was measured as increasing in temperature from 50° C. to 75° C. over a period of about 370 seconds as shown in the graph of FIG. 2. This corresponds to a heat transfer rate that yields 0.07° C. temperature rise/second, a much lesser rate, and one that will not cause an ignition of the contained fluid and resulting fire. The test results show that the fluid in the coated tank heated at a rate of more than four (4) times slower than did the uncoated tank. At the conclusion of each burn period, if the tank was intact, it was allowed to cool to a temperature low enough for handling and was then subjected to a post-fire leak test of ¼ PSIG.

A summary of the test results is as follows:

| | Intumescent | Duration of Flame | | |
|---|---|---|---|---|
| Tank | Coating? | Exposure | | Results |
| B1 | No | 2½ | minutes | Tank had a material flow from the heat |
| | | | | imposed on the plastic material and as a |
| | | | | result, a hole opened in the tank following the |
| | | | | flame exposure. |
| B2 | No | 2½ | minutes | Tank had a material flow during the flame |
| | | | | exposure and as a result, a hole opened in |
| | | | | the tank during the burn period. |
| B3 | No | 2½ | minutes | Tank had a material flow from the heat |
| | | | | imposed on the plastic material and as a |
| | | | | result, a hole opened in the tank following the |
| | | | | flame exposure. |
| B4 | No | 2½ | minutes | Tank had a material flow from the heat |
| | | | | imposed on the plastic material and as a |
| | | | | result, a hole opened in the tank following the |
| | | | | flame exposure. |
| B3A | Yes | 2½ | minutes | Tank passed the burn test and the post-fire |
| | | | | leak test. |
| B36 | Yes | 5 | minutes | Tank passed the burn test and the post-fire |
| | | | | leak test. |

Thus, the results of this fuel tank testing show the effectiveness of the surface modification method in that the intumescent coating was retained on the coated tanks, B3A and B3B, for 2½ minutes and 5 minutes, respectively, during the flame tests. Further, the testing shows the fire-protection effectiveness of the intumescent coating itself in preventing failure of the plastic fuel tanks which otherwise occurred in the absence of the intumescent coating.

It is possible to manufacture containers in a variety of shapes and sizes using surface modified particles such that the resulting formed (molded) containers have a significantly increased surface energy that enables good surface adhesion. In order to accomplish this the containers must be formed utilizing the rotational molding process. Further, this molding process is required to be performed under exacting conditions such that the resin particles sinter, i.e. thermally bond at the particle-particle interface, but do not melt. If the particles are allowed to melt, the polar functionality from the surface modification (described above) will be buried within the resin and not be retained at the surface. This will result in the molded container failing to gain the intended increase in surface energy such that any coating adhesion will be insufficient and result in premature failure.

The present invention may be embodied in other specific forms without departing from the spirit or essential attributes thereof and, accordingly, the described embodiments are to be considered in all respects as being illustrative and not restrictive, with the scope of the invention being indicated by the appended claims, rather than the foregoing detailed description, as indicating the scope of the invention as well as all modifications which may fall within a range of equivalency which are also intended to be embraced therein.

1. A method for manufacturing a plastic article having superior fire-resistive properties, said method comprising the steps of:
modifying at least one surface of said article to have superior adhesion properties by contacting that surface with a reactive gas atmosphere containing F₂, Cl₂, O₂, O₃, SO₃, peroxide, oxidative acids, or mixtures thereof, at a temperature and partial pressure sufficient to increase the surface energy of the at least one surface being modified to at least 40 dynes/cm;
applying a fire resistive coating to the modified surface; and,
curing said fire resistive coating.

2. The method of claim 1, wherein the material from which said article is formed is selected from the group consisting of polyethylene, polypropylene, nylon, polyester, polyurethane, epoxy, PVC, acetal, and polystyrene.

3. The method of claim 1, wherein the material from which said fire resistive coating is formed is selected from the group consisting of water-based intumescents, epoxy-based intumescents, polyurethane intumescents, urea-formaldehyde-based intumescents, and ceramic-based microspheres impregnated in a polymer-resin binder.

4. The method of claim 1, wherein the method comprises the further step of applying a barrier coating under the fire resistive coating, the material from which said barrier coating is formed is selected from the group consisting of epoxy, novolac, polyvinylidine dichloride, polyvinylchloride, polyacrylonitrile, polyurethane, polyurea, urea-formaldehyde, organopolysiloxane, unsaturated polyester, and copolymers thereof.

5. The method of claim 1, wherein said article is formed into a tank, fluid vessel, pipe, tube or other container or fluid transport vessel.

6. The method of claim 1, wherein said at least one treated surface is the outer surface of said article.

7. A method for manufacturing a plastic article having superior fire-resistive properties, said method comprising the steps of:
modifying the surface of particles of polymer material to be made into said article to have superior adhesion properties by contacting the surface of said particles with a reactive gas atmosphere containing F₂, Cl₂, O₂, O₃, SO₃, peroxide, oxidative acids, or mixtures thereof, at a temperature and partial pressure sufficient to increase the surface energy of the particles of material being modified to at least 40 dynes/cm;
forming said articles using said surface modified particles;
applying a fire resistive coating to the modified surface; and,
curing said fire resistive coating.

8. The method of claim 7, wherein the surface modified particles of material from which said article is formed is selected from the group consisting of polyethylene, polypropylene, nylon, polyester, polyurethane, epoxy, PVC, acetal, and polystyrene.

9. The method of claim 7, wherein the material from which said fire resistive coating is formed is selected from the group consisting of water-based intumescents, epoxy-based intumescents, polyurethane intumescents, urea-formaldehyde-based intumescents, and ceramic-based microspheres impregnated in a polymer-resin binder.

10. The method of claim 7, wherein the method comprises the further step of applying a barrier coating under the fire resistive coating, the material from which said barrier coating is formed is selected from the group consisting of epoxy, novolac, polyvinylidine dichloride, polyvinylchloride, polyacrylonitrile, polyurethane, polyurea, urea-formaldehyde, organopolysiloxane, unsaturated polyester, and copolymers thereof.

11. The method of claim 7, wherein said article is formed into a tank, fluid vessel, pipe, tube or other container or fluid transport vessel.

12. A plastic article having superior permeation barrier properties, impact resistance, and fire-resistive properties, said article being formed into an enclosed shape having an inner and an outer surface, the outer surface being modified by contacting that surface with a reactive gas atmosphere containing F₂, Cl₂, O₂, O₃, SO₃, peroxide, oxidative acids, or mixtures thereof, at a temperature and partial pressure sufficient to increase the surface energy of the said outer surface being modified to at least 40 dynes/cm, a barrier coating applied to said outer modified surface and adhering thereto, and a fire resistive coating applied to said barrier coating and adhering thereto.

13. The plastic article of claim 12, wherein the material from which said article is formed is selected from the group consisting of polyethylene, polypropylene, nylon, polyester, polyurethane, epoxy, PVC, acetal, and styrene.

14. The plastic article of claim 12, wherein the material from which said barrier coating is formed is selected from the group consisting of epoxy, novolac, polyvinylidine dichloride, polyvinylchloride, polyacrylonitrile, polyurethane, polyurea, urea-formaldehyde, organopolysiloxane, unsaturated polyester, and copolymers thereof.

15. The plastic article of claim 12, wherein the material from which said fire resistive coating is formed is selected from the group consisting of water-based intumescents, epoxy-based intumescents, polyurethane intumescents, urea-formaldehyde-based intumescents, and ceramic-based microspheres impregnated in a polymer-resin binder.

16. The plastic article of claim 12, wherein the enclosed shape forms a tank, a fluid vessel, pipe, tube or other container or fluid transport vessel.

17. A plastic article having superior fire-resistive properties, at least one surface of said article being modified by contacting the at least one said surface with a reactive gas atmosphere containing F₂, Cl₂, O₂, O₃, SO₃, peroxide, oxidative acids, or mixtures thereof, at a temperature and partial pressure sufficient to increase the surface energy of that surface being modified to at least 40 dynes/cm, and a fire resistive coating applied to said modified surface and adhering thereto.

18. The plastic article of claim 17, wherein the material from which said article is formed is selected from the group consisting of polyethylene, polypropylene, nylon, polyester, polyurethane, epoxy, PVC, acetal, and styrene.

19. The plastic article of claim 17, wherein the material from which said fire resistive coating is formed is selected from the group consisting of water-based intumescents, epoxy-based intumescents, polyurethane intumescents, urea-formaldehyde-based intumescents, and ceramic-based microspheres impregnated in a polymer-resin binder.

20. The plastic article of claim 17, wherein the enclosed shape forms a tank, fluid vessel, pipe, tube or other container or fluid transport vessel.

21. A plastic article having superior fire-resistive properties, more than one surface of said article being modified by contacting said surfaces with a reactive gas atmosphere containing F₂, Cl₂, O₂, O₃, SO₃, peroxide, oxidative acids, or mixtures thereof, at a temperature and partial pressure sufficient to increase the surface energy of the surfaces being modified to at least 40 dynes/cm, and a fire resistive coating applied to said modified surfaces and adhering thereto.

22. The plastic article of claim 21, wherein the material from which said article is formed is selected from the group consisting of polyethylene, polypropylene, nylon, polyester, polyurethane, epoxy, PVC, acetal, and styrene.

23. The plastic article of claim 21, wherein the material from which said fire resistive coating is formed is selected from the group consisting of water-based intumescents, epoxy-based intumescents, polyurethane intumescents, urea-formaldehyde-based intumescents, and ceramic-based microspheres impregnated in a polymer-resin binder.

24. The plastic article of claim 21, wherein the enclosed shape forms a tank, fluid vessel, pipe, tube or other container or fluid transport vessel.

25. The plastic article of claim 21, wherein one of the more than one treated surfaces is the inner surface of said article, said inner modified surface having a barrier coating applied and adhered thereto, the material from which said barrier coating is formed is selected from the group consisting of epoxy, novolac, polyvinylidine dichloride, polyvinylchloride, polyacrylonitrile, polyurethane, polyurea, urea-formaldehyde, organopolysiloxane, unsaturated polyester, and copolymers thereof.
